(19) United States
(12) Patent Application Publication
(10) Pub. No.: US 2015/0291002 A1
(43) Pub. Date: Oct. 15, 2015

(54) VEHICLE COOLING SYSTEM

(71) Applicant: Ford Global Technologies, LLC, Dearborn, MI (US)

(72) Inventor: Mark G. Smith, Canton, MI (US)

(73) Assignee: Ford Global Technologies, LLC, Dearborn, MI (US)

(21) Appl. No.: 14/252,995

(22) Filed: Apr. 15, 2014

(51) Int. Cl. B60H 1/00; B60H 1/32

(52) U.S. Cl. CPC B60H 1/00278; B60H 1/00885; B60H 1/323

(57) ABSTRACT

A vehicle includes a cabin, an auxiliary unit, a cooling arrangement that includes a condenser and a plurality of cooling loops, and a controller. The cooling loops are arranged to transport heat from cabin air and the auxiliary unit to the condenser. In response to an auxiliary unit cooling request while the cooling arrangement is cooling the cabin air, the controller is programmed to ramp-up the fluid flow at a specified rate through portions of the cooling loops that are arranged to cool the auxiliary unit in order to dampen a rate of increase in the cabin air temperature.

### TECHNICAL FIELD

The present disclosure relates to cooling systems in vehicles.

### BACKGROUND

Many vehicles are equipped with heating, ventilation, and air conditioning (HVAC) systems that are utilized to heat or cool the cabin air of the vehicle, in order to bring the cabin air temperature to a desired comfort level. The air conditioning system component of the HVAC system utilizes a refrigerant that absorbs heat from air that is being introduced into the cabin and then rejects the heat to the ambient air.

### SUMMARY

In one aspect of the disclosure, a vehicle having a cooling arrangement including a condenser and cooling loops arranged to cool both cabin air in the vehicle and a battery via the condenser is disclosed. A controller is programmed to, in response to a battery cooling request received while the cooling arrangement is cooling the cabin, increase at a specified rate fluid flow through the portions of the cooling loops that are arranged to cool the battery in order to dampen a rate of increase in the cabin air temperature.

In another aspect of the disclosure, a vehicle having a cooling arrangement including a condenser and a plurality of cooling loops arranged to cool both cabin air in the vehicle and an auxiliary unit via the condenser is disclosed. A controller is programmed to, while the cooling arrangement is cooling the cabin air and not the auxiliary unit, gradually increase fluid flow through the portions of the cooling loops arranged to cool the auxiliary unit in order to control a rate at which thermal load from the auxiliary unit is introduced to the condenser.

In yet another aspect of the disclosure, a cooling method for a vehicle having a cooling arrangement with a plurality of cooling loops arranged to cool the air in a cabin and an auxiliary unit via a condenser is disclosed. The method includes increasing fluid flow through portions of the cooling loops that are arranged to cool the auxiliary unit in order to dampen an increase in cabin air temperature, when the auxiliary unit requires cooling while the cooling arrangement is cooling the cabin air and not the auxiliary unit. A signal indicative of an auxiliary unit temperature or the fluid temperature in a secondary cooling loop that is arranged to transfer heat from the auxiliary unit to the portions of the plurality of cooling loops that are arranged to cool the auxiliary unit may be utilized to indicate that the auxiliary unit requires cooling. Also, the auxiliary unit may be a battery.

### BRIEF DESCRIPTION OF THE DRAWINGS

FIG. 1 is graph illustrating the temperature of the cabin air and the temperature of the air at the time it exits the vents and flows into the cabin;

FIG. 2 is a schematic illustrating a vehicle;

FIG. 3 illustrates a system for cooling cabin air and an auxiliary unit according to one embodiment of the present disclosure;

FIG. 4 illustrates a system for cooling cabin air and an auxiliary unit according to a second embodiment of the present disclosure;

FIG. 5 illustrates a thermal expansion valve having a restricting device incorporated therein; and

FIG. 6 is a graph illustrating the effects of ramping up fluid flow rate and limiting the fluid flow in a cooling loop that is utilized to cool an auxiliary unit in a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Refrigerant from an air conditioning system may be diverted and used to absorb heat from other vehicle components. However when refrigerant is diverted from the from the air conditioning system, disruptions may occur that cause sudden spikes in the temperature level of the vehicle cabin which in turn may cause discomfort to the vehicle driver and/or passengers. It may be desirable to provide a system that would prevent sudden spikes in the temperature of the vehicle cabin, preventing the potential discomfort to the vehicle driver and/or passengers.

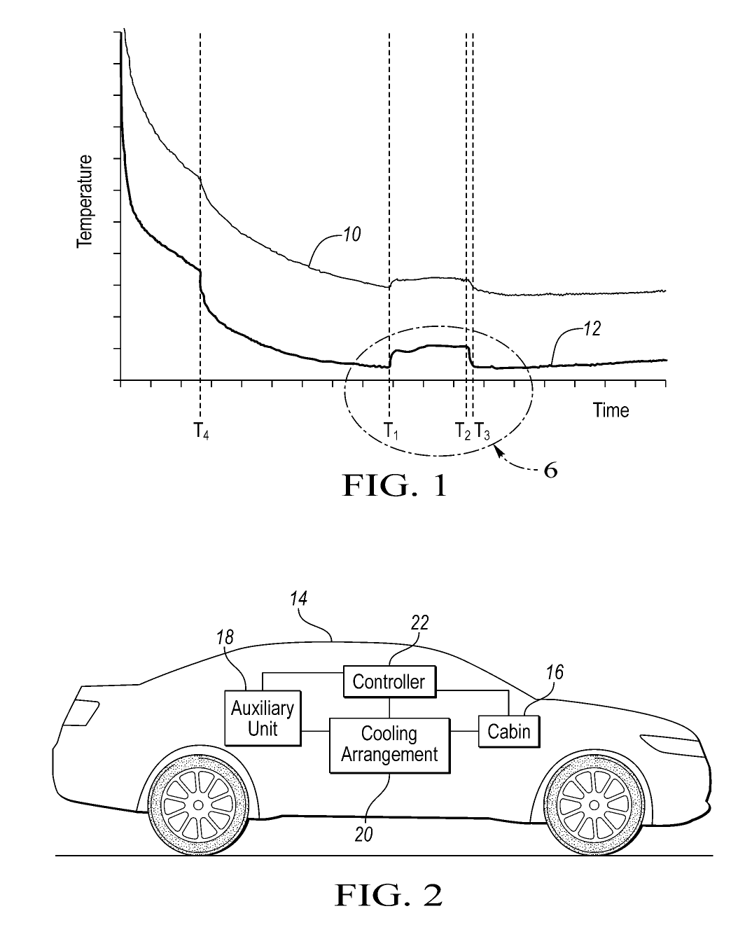

Referring to the graph in FIG. 1, one measurement of cabin air temperature versus time is illustrated by line 10. Also shown is the temperature measurement of the air as it exits the ventilation ducts and enters the cabin of the vehicle versus time, which is illustrated by line 12. The temperature measurements begin at approximately zero minutes as the vehicle air conditioning system is turned on. Both temperature measurements 10, 12 appear to decrease relatively quickly during the time period immediately after the air conditioning system has been turned on. The rates at which the temperature readings decrease appear to decrease over time however, and the temperature measurements 10, 12 eventually reach an approximately steady state temperature toward the right side of the graph.

Toward the middle of the graph, there is an increase in both temperature measurements 10, 12 which approximately takes the form of a square wave. The increase in the temperature measurements represents a demand for cooling to an auxiliary system in the vehicle. The refrigerant in the cooling loop of the auxiliary system ties into the same system that cycles refrigerant through the vehicle air conditioning system. Because the two systems are tied together, additional heat is introduced into the refrigerant when both the air conditioning system is operating and auxiliary system is being cooled. The heat is eventually rejected to the ambient air through a condenser. The auxiliary system is cooled beginning at time T₁ and ending at time T₂. The temperature increase that begins at time T₁ reaches a maximum value over a relatively short period of time which may be experienced by the driver and/or passengers in the vehicle causing them discomfort. Once the auxiliary system no longer requires cooling and is turned off at time T₂, the steady state temperature is once again obtained at time T₃.

An increase in the rate of cooling for both temperature measurements 10, 12 may also be observed at time T₄. This increase in rate correlates with an event in which cooling to the auxiliary system is turned off while the air condition system for the cabin continues to operate, when prior to the event the air conditioning system and cooling of auxiliary system were operating simultaneously.

Referring to FIG. 2, a vehicle 14 having a cabin 16, an auxiliary unit 18, and a cooling arrangement 20 is illustrated. The cooling arrangement 20 is arranged to absorb heat from the cabin air and the auxiliary unit 18 and transport the heat to a heat exchanger (i.e., condenser), which then rejects the heat to the ambient air. A system controller 22 is utilized to coordinate the cooling of the cabin air with the cooling of the auxiliary unit 18. The controller 22 is shown as one controller, but may consist of one or several different system controllers. The auxiliary unit may include one of several vehicle systems, such as a traction battery in an electric or hybrid vehicle, a traction motor in an electric or hybrid vehicle, an inverter in an electric or hybrid vehicle, any power electronics in the vehicle, a transmission including the transmission electronics and/or the transmission fluid, a turbocharger, a supercharger, a fuel cell exhaust gas waster condenser, cooling of diesel fuel in a diesel operated vehicle, or cooling of engine oil. This list is not meant to be exhaustive and it should be understood that the system could be utilized to cool any auxiliary unit that may require additional cooling.

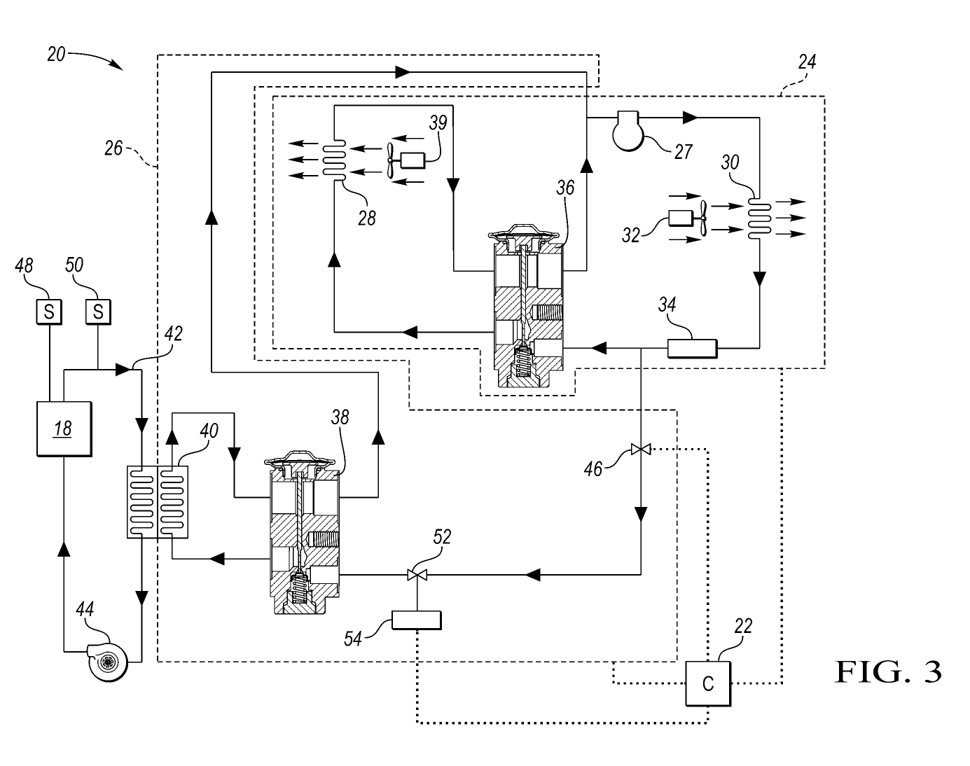

Referring to FIG. 3, one embodiment of the cooling arrangement 20 is illustrated. The cooling arrangement 20 includes a plurality of cooling loops 24, 26. A refrigerant is cycled through the cooling loops 24, 26 which absorbs heat either from the cabin air or the auxiliary unit 18 and rejects the heat to the ambient air. The first cooling loop 24 includes a compressor 27 which takes in low pressure, low temperature refrigerant that is in a vapor state and is coming out of an evaporator 28. The low pressure, low temperature vapor refrigerant that is exiting the evaporator 28 is a superheated gas. The compressor 27 then compresses the refrigerant into a high pressure, high temperature vapor which is then sent to a condenser 30. The high pressure, high temperature vapor refrigerant is passed through the condenser 30, which includes a coil, where a condenser fan 32 blows ambient air across the coil and heat is transferred from the high pressure, high temperature vapor refrigerant to the ambient air blowing across the coil. The refrigerant exiting the condenser is a high pressure, high temperature liquid that then enters a receiver-drier 34. The receiver-drier 34 serves as a filter that removes any moisture and some contaminants that get into the cooling loops 24, 26. The receiver-drier 34 contains a desiccant that removes moisture from the refrigerant. The condenser 30 and receiver-drier 34 may be combined into a single unit.

After leaving the receiver-drier, the refrigerant still in the high pressure, high temperature liquid state, then enters a thermal expansion valve (TXV) 36. The TXV 36 controls the amount of refrigerant entering the evaporator 28. If the temperature of the refrigerant leaving the evaporator is too hot, the TXV 36 opens allowing more liquid refrigerant to flow into the evaporator 28. If the temperature of the refrigerant leaving the evaporator is to cold, the TXV 36 closes reducing the amount of refrigerant flowing into the evaporator.

The TXV 36 restricts the flow of the refrigerant causing a pressure drop in the refrigerant. The TXV 36 includes a valve needle that remains open during steady state operation. The size of the opening or the position of the needle is related to the pressure and temperature of the refrigerant exiting the evaporator.

There are two main parts of the TXV 36 that regulate the position of the needle. First is the thermo-head which has a diaphragm. One side of the diaphragm is sealed and filled with refrigerant while the superheated refrigerant exiting the evaporator 28 flows past the opposite side of the diaphragm. A change in temperature of the superheated refrigerant creates a change in pressure on the diaphragm, controlling the opening and closing of the TXV 36. Since the pressure before the TXV 36 is higher than the pressure after the TXV 36, the refrigerant naturally flows into the evaporator 28. The second part of the TXV 36 that regulates the position of the needle is a spring providing a continuous force on a valve stem biasing the needle in the closed position. The spring force constantly restricts the amount of refrigerant entering the evaporator 28. When the pressure of the sealed refrigerant acting on the diaphragm is greater than the combined pressure of the superheated refrigerant exiting the evaporator 28 and the force from the spring, the valve opens to increase the flow of the refrigerant. An increase of flow lowers the superheat of the refrigerant leaving the evaporator 28 and the process repeats until a balanced condition is attained.

Although a block type thermal expansion valve was described, other types of thermal expansion valves may be utilized. For example a thermal expansion valve having a sensor bulb that remotely monitors the temperature change of the evaporator may be used. Another example would be a pressure compensated thermal expansion valve.

The refrigerant then leaves the TXV 36 in a low pressure, low temperature liquid and vapor mixture and enters the evaporator 28, which includes a coil, where a blower fan 39 blows air across the coil and heat is transferred from the air and into the refrigerant. The cooled air is then introduced into the vehicle cabin 16. The refrigerant leaving the evaporator 28 is a low pressure, low temperature superheated vapor that then flows through the TXV 36 on one side of the diaphragm, and then again to the compressor 27, where the cycle then repeats itself

Still referring to FIG. 3, the second cooling loop 26, branches off the first cooling loop 24 just after the receiver-drier 34 and channels high pressure, high temperature liquid refrigerant to a second TXV 38. The refrigerant then exits the second TXV 38 in a low pressure, low temperature liquid and vapor mixture, where it then enters a chiller 40. Heat is transferred from the auxiliary unit 18 to the refrigerant in the chiller 40. The refrigerant then exits the chiller 40 in low pressure, low temperature superheated vapor state where it is again passed through the second TXV 38 to control the opening and closing of the second TXV 38. The refrigerant still in the low pressure, low temperature superheated vapor state then is channeled back into the first cooling loop 24 and to the compressor 27.

The auxiliary unit 18 may have a coolant loop 42 that cycles a coolant, such as glycol, through the auxiliary unit 18 and the chiller 40. The coolant is cycled through the coolant loop 42 with a pump 44, and heat is transferred first from the auxiliary unit 18 to the coolant, and second from the coolant to the refrigerant in the chiller 40.

The second cooling loop 26 may contain a shut off valve 46 that turns off the second cooling loop 26 when the auxiliary unit 18 does not require cooling. The system controller 22 receives a signal indicative of the temperature of the auxiliary unit 18 and/or the temperature of the coolant in the coolant loop 42. When the temperature of the auxiliary unit 18 and/or the coolant reaches a level where the auxiliary unit 18 requires cooling, the valve 46 opens allowing refrigerant to flow through the second cooling loop 26. The temperatures of the auxiliary unit 18 or the coolant in the cooling loop 42 may be detected by temperature sensors 48, 50, respectively, that send the signal to the controller 22 indicating that cooling of the auxiliary unit 18 is required.

A metering device 52 may be incorporated into the second cooling loop 26 in order to control the amount of refrigerant that is allowed to flow through the second cooling loop 26. The metering device 52 can be variably adjusted between a fully opened position and a fully closed position, including any partially opened position in-between. The metering device 52 could be any type of metering valve that is capable of throttling or regulating the amount of refrigerant flowing into the second cooling loop 26. The types of metering valves that may be utilized may include but are not limited to needle valves, butterfly valves, ball valves, plug valves, etc. Although in FIG. 3 the meter device 52 is placed in the second cooling loop 26 just prior to when the high pressure, high temperature liquid refrigerant enters the second TXV 38, it should be noted that the meter device 52 could be placed at any position within the second cooling loop 26.

The position of the metering device 52 may be adjusted with an actuator 54 which is being controlled by the controller 22. The actuator 54 may be any type of mechanism that allows movement in increments, such as a stepper motor or a servo motor. The actuator 54 may include a gear box that increases or decreases the ratio of movement of the metering device 52 relative to the actuator 54. In response to a cooling request from the auxiliary unit 18 while the cooling arrangement 20 is cooling the cabin air, the controller may be programmed to ramp up at a specified rate the fluid flow of the refrigerant through the second cooling loop 26 by gradually opening the metering device 52, in order to control the rate at which the thermal load from the auxiliary unit 18 is introduced to the system 20 and condenser 30. Ramping the rate of fluid flow of the refrigerant dampens a rate of increase in the temperature of the air exiting the ventilation duct and the corresponding rise of the cabin air temperature in order to prevent sudden spikes in temperature when the auxiliary unit 18 calls for cooling while at the same time the cooling arrangement is also being utilized to cool the air in the cabin 16.

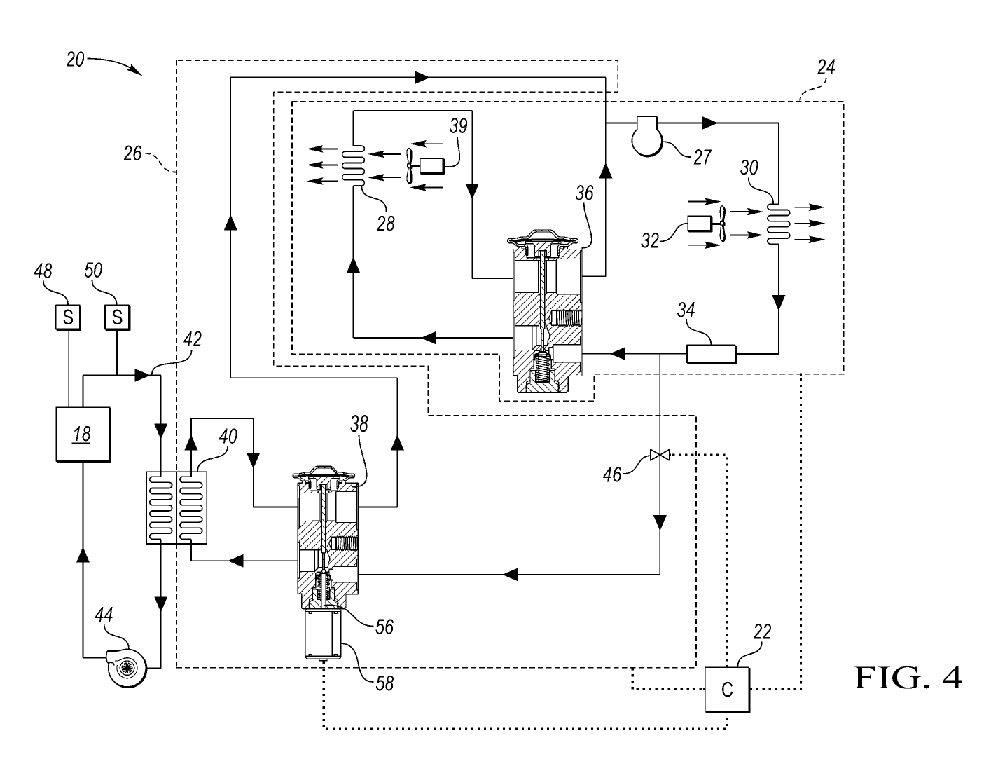

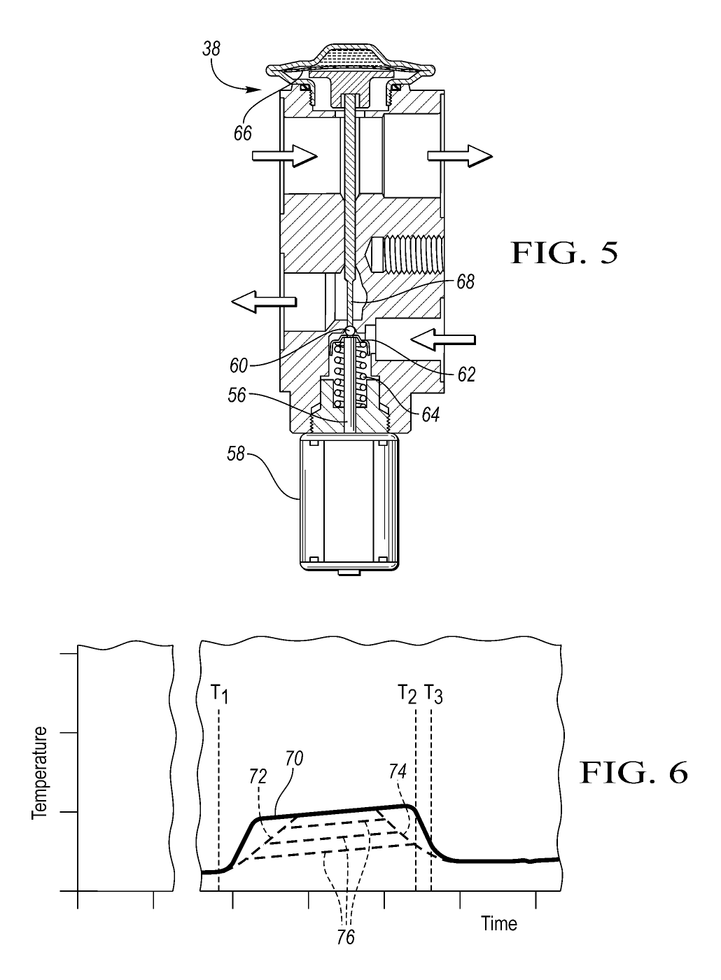

Referring now to FIGS. 4 and 5, a second embodiment of the cooling arrangement 20 is illustrated. The second embodiment does not include the metering device 52 and actuator 54 depicted in the first embodiment, but does however include a metering device that is incorporated into the second TXV 38. The metering device incorporated in the second TXV 38 can variably adjust the second TXV 38 between a fully opened position and a fully closed position, including any partially opened position in-between. The metering device incorporated into the second TXV 38 may consist of a restricting device 56 and an actuator 58. The restricting device 56 may take the form of an adjustable shaft that is capable of restricting a partially or fully opened position of the second TXV 38. A ball valve 60 in the second TXV 38 is kept closed with a cup 62 and a biasing member 64, such as a spring. A diaphragm 66 in the second TXV 38 has one side that is sealed and filled with refrigerant while the second side is exposed to the superheated refrigerant exiting the chiller 40. The diaphragm 66 is connected to a valve needle 68 that pushes down on the ball valve 60 to open the second TXV 38 when the difference in pressure on each side of the diaphragm 66 reaches a threshold that overcomes the force of the biasing member 64, allowing an increased flow of refrigerant into the chiller 40.

The position of the restricting device 56 may be adjusted with the actuator 58 which is being controlled by the controller 22. The actuator 58 may be any type of mechanism that allows movement in increments, such as a stepper motor or a servo motor. The actuator 58 may include a gear box that increases or decreases the ratio of movement of the restricting device 56 relative to the actuator 58. In response to a cooling request from the auxiliary unit 18 while the cooling arrangement 20 is cooling the cabin air, the controller 22 may be programmed to ramp up at a specified rate the fluid flow of the refrigerant through the second cooling loop 26 by gradually opening up the second TXV 38 with the restricting device 56, in order to control the rate at which the thermal load from the auxiliary unit 18 is introduced to the system 20 and the condenser 30. This may be accomplished by restricting the open position of the ball valve 60 with the restricting device 56. Ramping up the rate of fluid flow of the refrigerant dampens a rate of increase in temperature of the air exiting the ventilation duct and the corresponding rise of the cabin air temperature in order to prevent sudden spikes in temperature when the auxiliary unit 18 calls for cooling while at the same time the cooling arrangement is also being utilized to cool the air in the cabin 16.

Referring now to FIG. 6, the solid line 70 illustrates either the square wave in line 12 of FIG. 1, that represents the temperature measurement of the air as it exits the ventilation ducts and enters the cabin 16 of the vehicle verses time; or the square wave in line 10 of FIG. 1, that represents the temperature measurement of the cabin air of a vehicle versus time. In either case, the dotted line 72 in FIG. 6 illustrates how the temperature of the air as it exits the ventilation ducts can be gradually increased by ramping up at a specified rate the fluid flow of the refrigerant through the second cooling loop 26 with the either the metering device 52 or the restricting device 56. The dotted line 74 illustrates how the temperature of the cabin air or the temperature of the air as it exits the ventilation ducts can be gradually decreased by ramping down at a specified rate the fluid flow of the refrigerant through the second cooling loop 26 with either the metering device 52 or the restricting device 56. The dotted horizontal lines 76 illustrate how the temperature of the cabin air or the temperature of the air as it exits the ventilation ducts can be limited as to how much of a temperature increase may occur when the fluid flow of the refrigerant through the second cooling loop 26 is limited to a level below a potential maximum fluid flow of the refrigerant with either the metering device 52 or the restricting device 56.

Although, a block type thermal expansion valve was described in the second embodiment, other types of thermal expansion valves may be utilized. For example a thermal expansion valve having a sensor bulb that remotely monitors the temperature change of the evaporator may be used. Another example would be a pressure compensated thermal expansion valve.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a cooling arrangement including a condenser and cooling loops arranged to cool each of cabin air and a battery via the condenser; and
a controller programmed to, in response to a battery cooling request received while the cooling arrangement is cooling the cabin, increase at a specified rate fluid flow through portions of the cooling loops arranged to cool the battery to dampen a rate of increase in cabin air temperature.

2. The vehicle of claim 1 further comprising a fluid metering device, wherein the controller is programmed to ramp-up the fluid flow at the specified rate by gradually opening the metering device.

3. The vehicle of claim 2, wherein the metering device is a metering valve configured to be variably adjusted between a fully closed position and a fully opened position.

4. The vehicle of claim 3 further comprising a stepper motor configured to adjust a position of the metering valve.

5. The vehicle of claim 2 further comprising a thermal expansion valve, wherein the metering device is integrated into the thermal expansion valve and is configured to variably adjust the thermal expansion valve between a fully closed position and a fully opened position.

6. The vehicle of claim 5, wherein the metering device includes a restricting device configured to limit an open position of the thermal expansion valve.

7. The vehicle of claim 6 further comprising a stepper motor configured to adjust a position of the restricting device.

8. A vehicle comprising:
a cooling arrangement including a condenser and a plurality of cooling loops arranged to cool each of cabin air and an auxiliary unit via the condenser; and
a controller programmed to, while the cooling arrangement is cooling the cabin air and not the auxiliary unit, gradually increase fluid flow through portions of the cooling loops arranged to cool the auxiliary unit so as to control a rate at which thermal load from the auxiliary unit is introduced to the condenser.

9. The vehicle of claim 8, wherein the auxiliary unit is a battery.

10. The vehicle of claim 8 further comprising a fluid metering device, wherein the controller is programmed to increase fluid flow at the rate specified by gradually opening the metering device.

11. The vehicle of claim 10, wherein the metering device is a metering valve configured to be variably adjusted between a fully closed position and a fully opened position.

12. The vehicle of claim 11 further comprising a stepper motor configured to adjust a position of the metering valve.

13. The vehicle of claim 8, wherein the metering device is integrated into a thermal expansion valve and is configured to variably adjust the thermal expansion valve between a fully closed position and a fully opened position.

14. The vehicle of claim 13, wherein the metering device includes a restricting device configured to limit an open position of the thermal expansion valve.

15. The vehicle of claim 14 further comprising a stepper motor configured to adjust a position of the restricting device.

16. The vehicle of claim 8, wherein the cooling arrangement includes at least one temperature sensor.

17. A cooling method for a vehicle including a cooling arrangement with a plurality of cooling loops arranged to cool each of cabin air and an auxiliary unit via a condenser, the method comprising:
when the auxiliary unit requires cooling while the cooling arrangement is cooling the cabin air and not the auxiliary unit,
increasing fluid flow through portions of the cooling loops arranged to cool the auxiliary unit to dampen increase in cabin air temperature.

18. The cooling method claim 17, wherein the auxiliary unit is a battery.

19. The cooling method claim 17, wherein a signal indicative of an auxiliary unit temperature is utilized to determine if the auxiliary unit requires cooling.

20. The cooling method of claim 17, wherein a signal indicative of a fluid temperature in a secondary cooling loop of the plurality of cooling loops is utilized to determine if the auxiliary unit requires cooling, and wherein the secondary cooling loop is arranged to transfer heat from the auxiliary unit to other portions of the plurality of cooling loops.
